(19) United States
(12) Patent Application Publication
(10) Pub. No.: US 2012/0200748 A1
(43) Pub. Date: Aug. 9, 2012

(54) IMAGE PROCESSING APPARATUS, ELECTRONIC CAMERA, AND STORAGE MEDIUM STORING IMAGE PROCESSING PROGRAM

(75) Inventor: Akihiko UTSUGI, Machida-shi (JP)

(73) Assignee: NIKON CORPORATION, Tokyo (JP)

(21) Appl. No.: 13/365,750

(22) Filed: Feb. 3, 2012

(30) Foreign Application Priority Data
Feb. 8, 2011 (JP) 2011-024599

(51) Int. Cl. H04N 5/217; G06K 9/40

(52) U.S. Cl. 348/241; 382/275; 348/E05.078

(57) ABSTRACT

An image processing apparatus includes an image importing unit importing an image, a storage unit storing pixel values of a plurality of pixels included in a predetermined range of the image, a first noise removal processing unit carrying out first noise removal processing for a pixel value of a target pixel which is a target of noise removal, with reference to the pixel values of the pixels stored in the storage unit, and a second noise removal processing unit carrying out second noise removal processing for a pixel value of the target pixel which is subjected to the first noise removal processing, successively immediately after the first noise removal processing by the first noise removal processing unit, with reference to the pixel values of the pixels stored in the storage unit.

### CROSS REFERENCE TO RELATED APPLICATION

This application is based upon and claims the benefit of priority from Japanese Patent Application No. 2011-024599, filed on Feb. 8, 2011, the entire contents of which is incorporated herein by reference.

### BACKGROUND

1. Field

The present application relates to an image processing apparatus, an electronic camera, and an image processing program.

2. Description of the Related Art

Conventionally, as noise removal processing for an image, processing using various filters such as a projection removal filter and a smoothing filter has been performed. For example, the projection removal filter is a filter used for removing projecting noise generated in an image and an example thereof is a MAX·MIN filter. This MAX·MIN filter obtains a maximum pixel value and a minimum pixel value of pixels positioned around a target pixel and clips the pixel value of the target pixel between the maximum pixel value and the minimum pixel value. Further, the smoothing filter is a filter used for removing shot noise generated in an image and an example thereof is an ε-filter. This ε-filter performs smoothing using the pixel value of a pixel in which a difference between the pixel value thereof and the pixel value of the target pixel is not larger than a threshold value, among pixels positioned around a target pixel, for example. Recently, in electronic cameras represents by a digital camera, noise removal processing is carried out in plural times by a pipeline method using the above projection removal filter and the smoothing filter (Japanese Unexamined Patent Application Publication No. 2004-7399).

When the noise removal processing is carried out in plural times using the above pipeline method, first, noise removal processing using the projection removal filter is carried out with reference to the pixel values of pixels stored in a first line memory, and the pixel values of the pixels subjected to the noise removal processing are stored in a second line memory. After that, noise removal processing using the smoothing filter is carried out with reference to the pixel values of the pixels stored in the second line memory. Accordingly, a line memory in accordance with an image size is required for each noise removal processing and there arises a problem that this leads to cost up.

### SUMMARY

The present embodiment aims at achieving cost down by saving a line memory used for noise removal processing which is performed in plural times with the use of a pipeline method.

For solving the above problem, an image processing apparatus includes an image importing unit importing an image, a storage unit storing pixel values of a plurality of pixels included in a predetermined range of the image, a first noise removal processing unit carrying out first noise removal processing for a pixel value of a target pixel which is a target of noise removal, with reference to the pixel values of the pixels stored in the storage unit, and a second noise removal processing unit carrying out second noise removal processing for a pixel value of the target pixel which is subjected to the first noise removal processing, successively immediately after the first noise removal processing by the first noise removal processing unit, with reference to the pixel values of the pixels stored in the storage unit.

The image processing apparatus further includes a third noise removal processing unit carrying out third noise removal processing for a pixel value of the target pixel which is subjected to the second noise removal processing, with reference to the pixel values of the pixels stored in the storage unit.

The first noise removal processing is processing which removes projecting noise included in the image.

The first noise removal processing is processing which performs anisotropic smoothing depending on a direction, and the second noise removal processing is processing which performs isotropic smoothing not depending on the direction.

The first noise removal processing is processing which removes projecting noise included in the image, the second noise removal processing is processing which performs anisotropic smoothing depending on a specific direction, and the third noise removal processing is processing which performs isotropic smoothing not depending on the direction.

An electronic camera includes an image sensor performing photoelectric conversion and an image processing apparatus, carrying out the noise removal processing for an image imported by the image sensor.

A non-transitory computer readable medium storing an image processing program causes a computer to execute an image importing step of importing an image, a storage step of storing pixel values of a plurality of pixels included in a predetermined range of the image, a first noise removal step of carrying out first noise removal processing for a pixel value of a target pixel which is a target of noise removal, with reference to the pixel values of the pixels stored by the storage step, and a second noise removal step of carrying out second noise removal processing for a pixel value of the target pixel which is subjected to the first noise removal processing, successively immediately after the first noise removal processing by the first noise removal step, with reference to the pixel values of the pixels stored by the storage step.

According to the present embodiment, it is possible to achieve cost down by saving a line memory used for the noise removal processing which is carried out in plural times with the use of the pipeline method.

### BRIEF DESCRIPTION OF THE DRAWINGS

FIG. 1 is a diagram showing an outline for a configuration of an image processing apparatus implementing the present embodiment.

FIG. 2 is a diagram showing a configuration of a noise removal unit in a first embodiment.

FIG. 3 is a diagram showing a relationship between an image and a pixel range to be stored in a line memory.

FIG. 4 is a diagram showing a pixel range to be referred to in projecting noise removal processing.

FIG. 5 is a diagram showing a pixel range to be referred to in smoothing processing.

FIG. 6 is a diagram showing a configuration of a noise removal unit in a second embodiment.

FIG. 7 is a diagram showing pixels to be referred to in anisotropic smoothing processing.

FIGS. 8A to 8D are diagrams showing pixels to be referred to when a pixel value distribution is obtained.

FIG. 9 is a diagram showing a configuration of an electronic camera including an image processing apparatus.

### DETAILED DESCRIPTION OF THE EMBODIMENTS

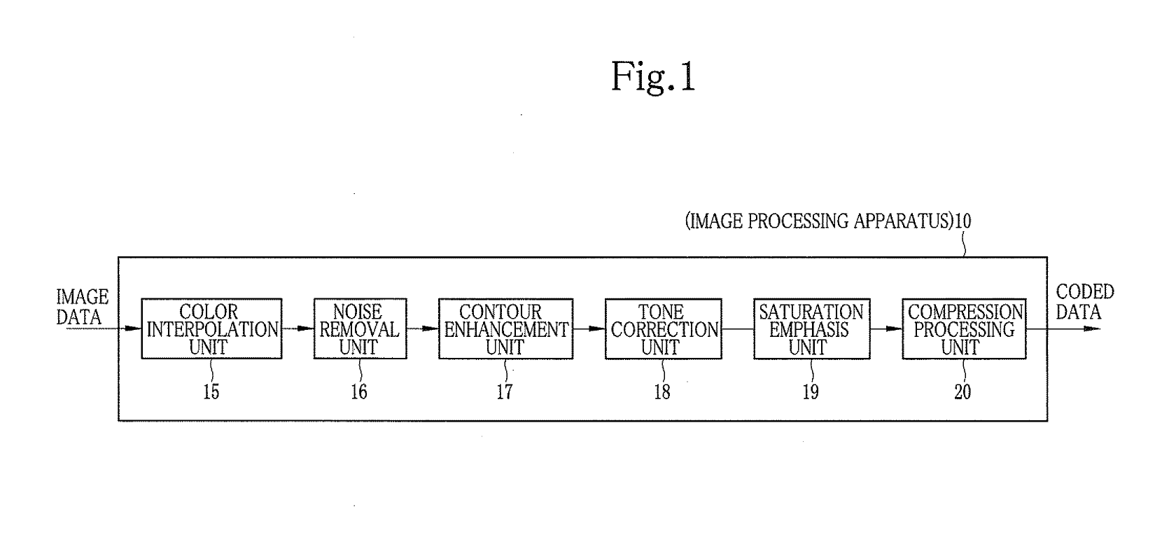

Hereinafter, an image processing apparatus implementing the present invention will be explained according to FIG. 1.

As shown in FIG. 1, an image processing apparatus 10 includes a color interpolation unit 15, a noise removal unit 16, a contour enhancement unit 17, a tone correction unit 18, a saturation emphasis unit 19, and a compression processing unit 20. This image processing apparatus 10 inputs image data in which the pixel value of each pixel includes any color component among R, G, and B. The color interpolation unit 15 performs color interpolation processing for the input image data and generates image data in which the pixel value of each pixel includes the color components of R, G, and B. After this color interpolation processing in the color interpolation unit 15, RGB-to-YCbCr conversion processing (omitted from the drawing) is carried out for the image data, and image data in which the pixel value of each pixel includes luminance (Y) and color differences (Cb and Cr) is generated. This image data is input into the noise removal unit 16. The noise removal unit 16 carries out noise removal processing for the input image data. This noise removal unit 16 will be described below in detail. The image data which has been subjected to the noise removal processing by the noise removal unit 16 is subjected to contour enhancement processing in the contour enhancement unit 17, tone correction processing in the tone correction unit 18, and saturation emphasis processing in the saturation emphasis unit 19. Here, the contour enhancement processing, the tone correction processing, and the saturation emphasis processing are well known and thus details thereof will be omitted. Lastly, the image data which has been subjected to each processing is subjected to compression coding processing by the compression processing unit 20 and output from the image processing apparatus 10 as coded data. Here, the image data output from the saturation emphasis unit 19 may be input directly into the compression processing unit 20 or may be input into the compression processing unit 20 after subjected to YCbCr-to-RGB conversion processing.

Here, while, as an example of the image data to be input into the image processing apparatus 10, image data in which the pixel value of each pixel includes any color component value among R, G, and B is used, the image data is not limited to this case and may be image data in which the pixel value of each pixel includes each of the color components, R, G, and B. in this case, the above color interpolation processing in the color interpolation unit 15 may be omitted and the image data may be input into the noise removal unit 16 after the RGB-to-YCbCr conversion processing has been provided.

Further, while the image processing apparatus shown in FIG. 1 is explained for a case in which both of the color interpolation unit 15 and the compression processing unit 20 are provided, the image processing apparatus is not limited to this case and may be an image processing apparatus in which either one of the color interpolation unit 15 and the compression processing unit 20 is not provided.

Hereinafter, an embodiment will be explained, as a first embodiment, for a case in which noise removal processing is carried out by processing removing projecting noise (hereinafter, projecting noise removal processing) and by smoothing processing, using a pipeline method.

### First Embodiment

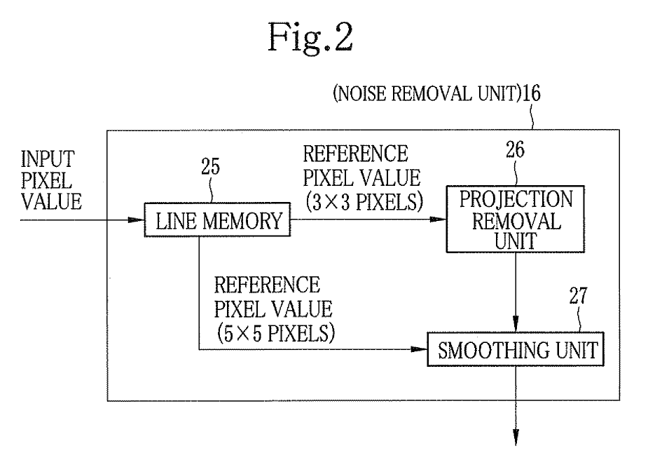

As shown in FIG. 2, the noise removal unit 16 includes a line memory 25, a projection removal unit 26, and a smoothing unit 27. While, in FIG. 2, the noise removal unit 16 has a form including one unit for each of the line memory 25, the projection removal unit 26, and the smoothing unit 27, each of the units in the noise removal unit 16 is preferably provided in a number corresponding to the number of color components.

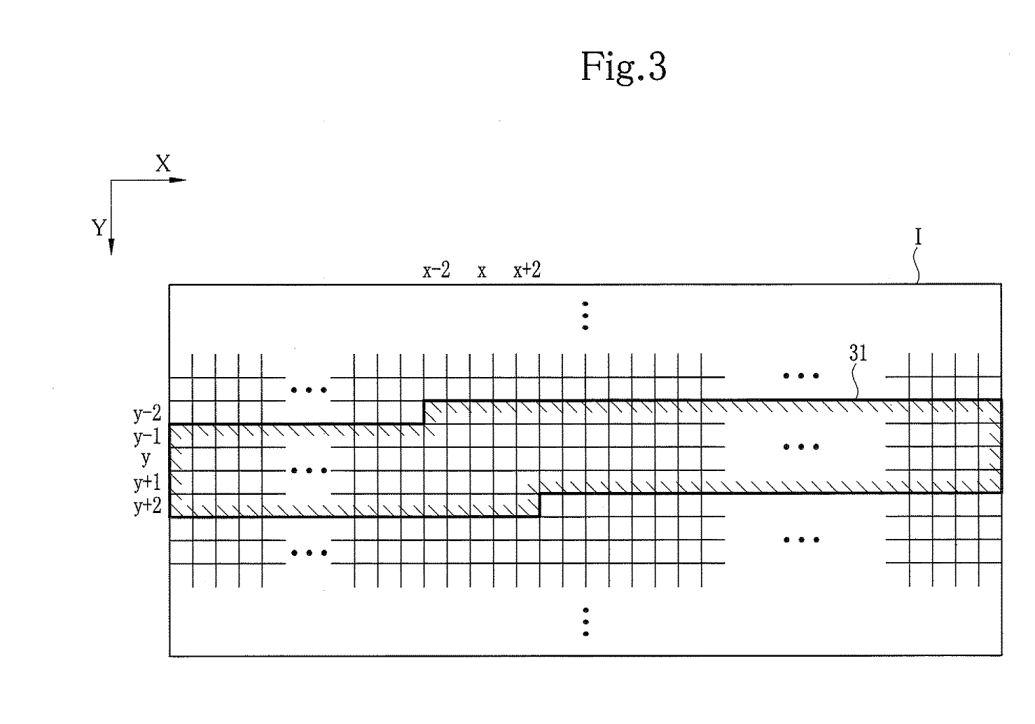

The line memory 25 stores the pixel value of each pixel of the image data input into the noise removal unit 16. Here, the number of pixels stored in the line memory 25 is the number of pixels arranged in five horizontal lines, for example, plus five pixels, for example. In FIG. 3, in an image I, a pixel range surrounded by hatching (range indicated by reference numeral 31) is a pixel range to be stored in the line memory 25, for example. This line memory 25 inputs the pixel value of each pixel in the image Ion a pixel-to-pixel basis, and, when the pixel values of the above number of pixels are stored, the projection removal unit 26 carries out the projecting noise removal processing. Then, after the smoothing unit 27 has finished the smoothing processing, the pixel value of the temporally oldest pixel is deleted from the line memory 25 and the pixel value of a newly input pixel is stored into the line memory 25. Note that the number of the pixels stored in the line memory 25 is an example and may be a number to be set optionally according to a pixel range referred to in the projection removal unit 26 and the smoothing unit 27.

The projection removal unit 26 carries out the projecting noise removal processing for a pixel which is a target of the noise removal (hereinafter, target pixel), with reference to the pixel values of the pixels stored in the line memory 25. This projecting noise removal processing in the projection removal unit 26 is carried out by the use of a MAX·MIN filter, for example. In the following, explanation will be given by defining the coordinates of the target pixel as (x, y) and the pixel value thereof as P(x, y). The MAX·MIN filter is a filter which obtains a maximum value (maximum pixel value) and a minimum value (minimum pixel value) of pixel values in pixels around the target pixel and clamps the pixel value of the target pixel to a value between the minimum pixel value and the maximum pixel value.

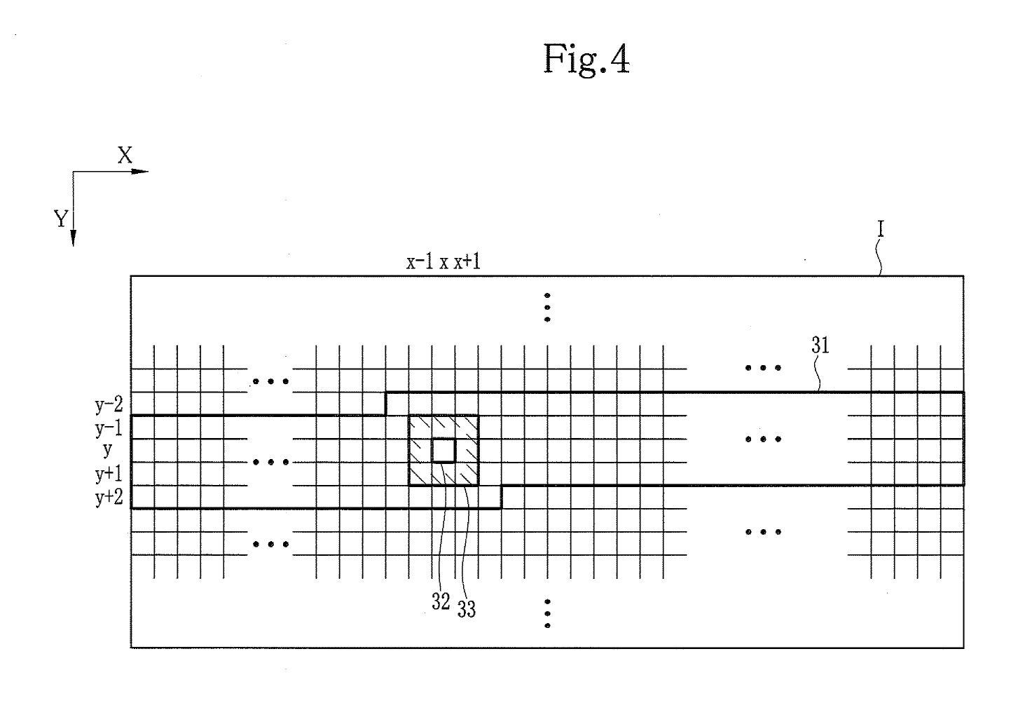

The projection removal unit 26 first reads out the pixel values of total nine pixels of 3×3 pixels centering the target pixel as the pixel values of reference pixels among the pixel values of the pixels stored in the line memory 25. FIG. 4 shows a case in which the pixel 32 at coordinates (x, y) is set as the target pixel, for example, and the pixel values of nine pixels included in the range 33 indicated by hatching in FIG. 4 are read out as the pixel values of the reference pixels.

Next, the projection removal unit 26 obtains a maximum pixel value and a minimum pixel value from reference pixels except the target pixel among the read out reference pixels, that is, from pixel values of pixels around the target pixel (in FIG. 4, total eight pixels of the coordinates (x−1, y−1), coordinates (x, y−1), coordinates (x+1, y−1), coordinates (x−1, y), coordinates (x+1, y), coordinates (x−1, y+1), coordinates (x, y+1), and coordinates (x+1, y+1)).

Lastly, the projection removal unit 26 applies the obtained maximum pixel value and minimum pixel value and the pixel value of the target pixel to following formula (1). Thereby, the projecting noise removal processing is carried out for the target pixel.

$$\begin{matrix}[ Formula 1 ] & \\ Q ( x , y ) = \{ \begin{matrix}MAX & if ( MAX ≦ P ( x , y ) ) \\ P ( x , y ) & if ( MIN < P ( x , y ) < MAX ) \\ MIN & if ( P ( x , y ) ≦ MIN )\end{matrix} & ( 1 )\end{matrix}$$

In the above formula (1), Q(x, y) shows the pixel value of the target pixel after the projecting noise removal processing, MAX shows the maximum pixel value in the pixels around the target pixel, and MIN shows the minimum pixel value of the pixels around the target pixel.

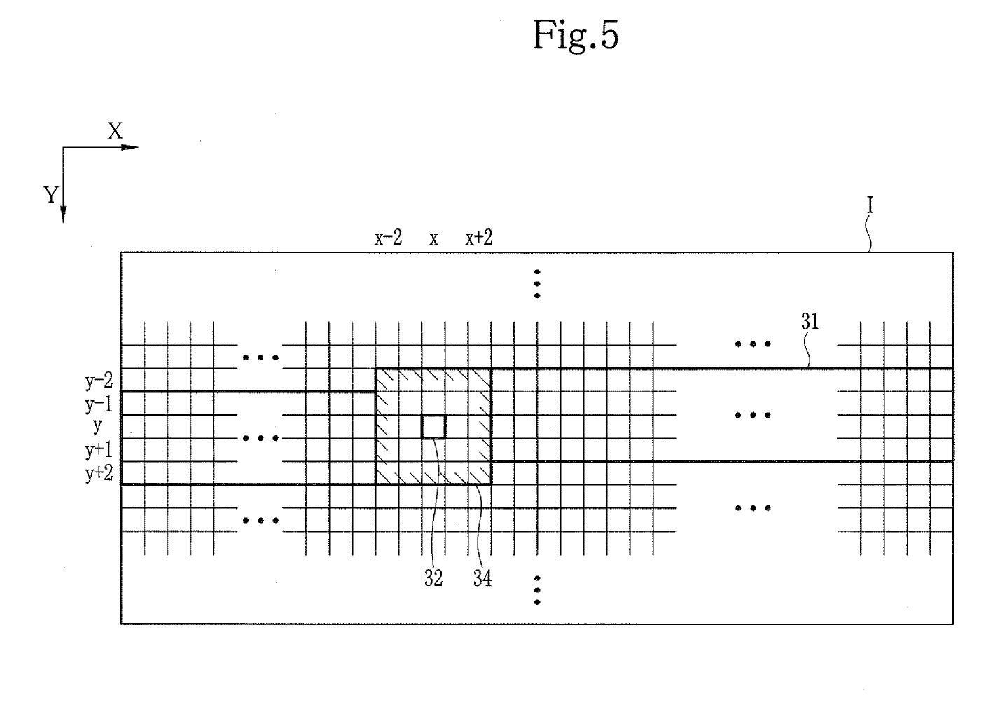

The smoothing unit 27 carries out the smoothing processing for the pixel value of the target pixel in which the projecting noise has been removed by the projection removal unit 26, with reference to the pixels stored in the line memory 25. This smoothing unit 27 carries out smoothing processing using an isotropic ε-filter not depending on a direction. Here, the ε-filter is a filter which performs smoothing using the pixel values of pixels around the target pixel and the pixel value of the target pixel in which the projecting noise has been removed. For a pixel range to be referred to in this smoothing unit 27, a range of total 25 pixels of 5×5 pixels centering the target pixel is read out as pixel values of reference pixels. Note that FIG. 5, as FIG. 4, shows a case in which the pixel 32 of coordinates (x, y) is defined as the target pixel and the pixel values of pixels included in the range 34 indicated by hatching in FIG. 5 are read out as pixel values of the reference pixels. This smoothing unit 27 carries out the smoothing processing for the target pixel according to following formula (2). In following formula (2), R(x, y) is the pixel value of the target pixel after the smoothing processing.

$$\begin{matrix}[ Formula 2 ] & \\ R ( x , y ) = Q ( x , y ) - \frac{1}{25} {\sum }_{i = - 2}^{2} {\sum }_{j = - 2}^{2} EPS ( Q ( x , y ) - P ( x + i , y + j ) , th 1 ) & ( 2 )\end{matrix}$$

Here, the function EPS(d, th) shown in above formula (2) is defined by following formula (3). Note that the coefficient th in formula (3) is a threshold value when the smoothing is performed (noise is removed).

$$\begin{matrix}[ Formula 3 ] & \\ EPS ( d , th ) ≡ \{ \begin{matrix}d & if ( \vert d \vert ≦ th ) \\ 0 & if ( \vert d \vert > th )\end{matrix} & ( 3 )\end{matrix}$$

The coefficient th1 in above formula (2) is set to be three times of the standard deviation of noise generated in an input image, for example. Note that, while the coefficient th1 is set to be three times of the standard deviation for the noise generated in the input image, the coefficient th1 is not necessarily limited to this value and can be set according to an imaging condition (shutter speed or the like) when the image is acquired, for example.

In the following, noise removal processing flow in the noise removal unit 16 will be explained. The image data subjected to the color interpolation processing by the color interpolation unit 15 is input into the noise removal unit 16 after subjected to the RGB-to-YCbCr conversion processing. Note that the noise removal unit 16 inputs the pixel value of each pixel on a pixel-to-pixel basis. The pixel value of each pixel input into the noise removal unit 16 is stored sequentially into the line memory 25. Then, when the number of the pixel values of pixels stored in the line memory 25 reaches a preliminarily set number, input of the pixel values of the pixels into the noise removal unit 16 is stopped.

When input of the pixel values of the pixels into the noise removal unit 16 has been stopped, the projection removal unit 26 reads out pixel values of total nine pixels of 3×3 pixels centering the pixel having the coordinate (x, y) of the target pixel and carries out the above projecting noise removal processing. Here, the pixel value of the target pixel which has been subjected to the projecting noise removal processing is output from the projection removal unit 26 to the smoothing unit 27. The smoothing unit 27 reads out pixel values of total 25 pixels of 5×5 pixels centering the target pixel, from the line memory 25. Then, the smoothing unit 27 carries out the above smoothing processing by referring to the pixel value of the target pixel which has been subjected to the projecting noise removal processing and output from the projection removal unit 26 and the pixel values of the pixels read out from the line memory 25. The pixel value of the target pixel which has been subjected to the smoothing processing in the smoothing unit 27 is output from the noise removal unit 16 to the contour enhancement unit 17.

When the pixel value of the target pixel which has been subjected to the smoothing processing by the smoothing unit 27 is output from the noise removal unit 16, the noise removal unit 16 inputs the pixel value of a new pixel. In time with this input, the pixel value of the temporally oldest pixel (e.g., pixel of the coordinates (x−2, y−2)) among the pixel values of the pixels stored in the line memory 25 is deleted from the line memory 25 and the pixel value of the newly input pixel (e.g., pixel of the coordinates (x+3, y+2)) is stored into the line memory 25. In this case, the pixel of the coordinates (x+1, y) which is shifted in the X-direction by one pixel from the pixel of the coordinates (x, y) is set as the target pixel, and the above projecting noise removal processing and smoothing processing are carried out.

In this manner, every time when all the pixels included in the predetermined range of an image are stored into the line memory 25 or when the pixel value of the pixel stored in the line memory 25 is updated, the above projecting noise removal processing and smoothing processing are carried out. These processing steps are carried out for all the pixels included in the image. Note that, when a pixel positioned at the right or left end part or the upper or lower end part of the image is set as the target pixel, some reference pixels around the target pixel do not exist sometimes. In such a case, pixels around the target pixel may be used redundantly or only pixels existing around the target pixel may be used.

This first embodiment performs both of the projecting noise removal processing and the smoothing processing using the pixel values of the pixels stored in the line memory 25. Further, the line memory 25 stores not the whole image but the pixel values of the pixels in the predetermined range including the pixels necessary for both of the projecting noise removal processing and the smoothing processing. That is, by carrying out the present invention, it is possible to minimize the capacity of the line memory 25 with respect to the noise removal processing and resultantly it is possible to suppress cost.

Note that, the smoothing processing carried out after the projecting noise removal processing uses the pixels stored in the line memory 25, in other words, uses the pixels which have not been subjected to the projecting noise removal processing. Accordingly, the smoothing processing is carried out using the pixel values in which projecting noise is generated. However, the projecting noise is generated sparsely in the image and the effect of the smoothing processing is not reduced even in a case of using the pixels not subjected to the projecting noise removal processing.

Next, a second embodiment will be explained for a case in which the projecting noise removal processing and plural times of the smoothing processing are performed. Here, a noise removal unit is denoted by attaching reference numeral 16 for explanation as in the first embodiment.

### Second Embodiment

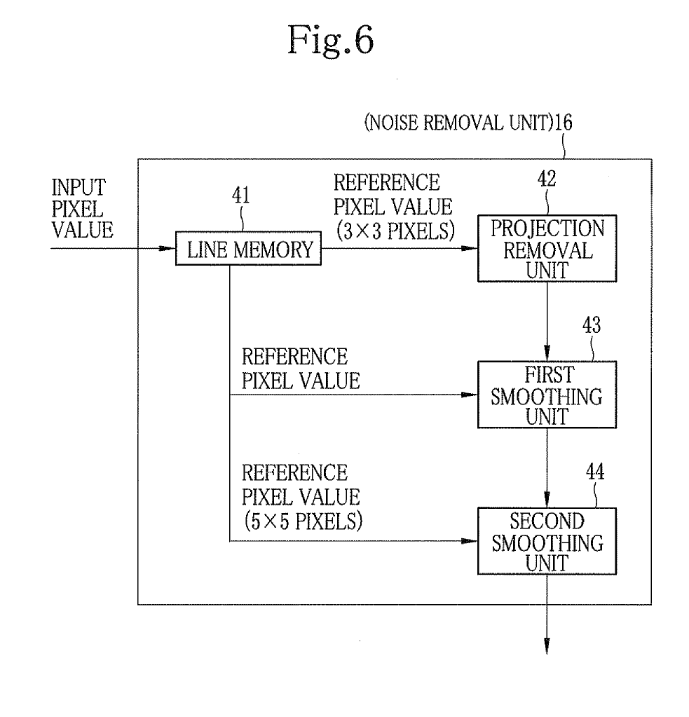

As shown in FIG. 6, the noise removal unit 16 includes a line memory 41, a projection removal unit 42, a first smoothing unit 43, and a second smoothing unit 44. Note that, while the configuration of the noise removal unit 16 shown in FIG. 6 is assumed to carry out the noise removal processing for one color component as in the first embodiment, when the noise removal processing is performed for each of the color components, it is preferable to provide the configuration of the line memory 41, the projection removal unit 42, the first smoothing unit 43, and the second smoothing unit 44 in a number corresponding to the respective color components. Note that the line memory 41 and the projection removal unit 42 have the same functions as those in the first embodiment and thereby detailed explanation thereof will be omitted here.

The first smoothing unit 43 carries out so-called anisotropic smoothing processing depending on a direction for the pixel value of a target pixel in which the projecting noise has been removed by the projection removal unit 42, with reference to pixels stored in the line memory 41. This first smoothing unit 43 carries out smoothing processing using an anisotropic ε-filter.

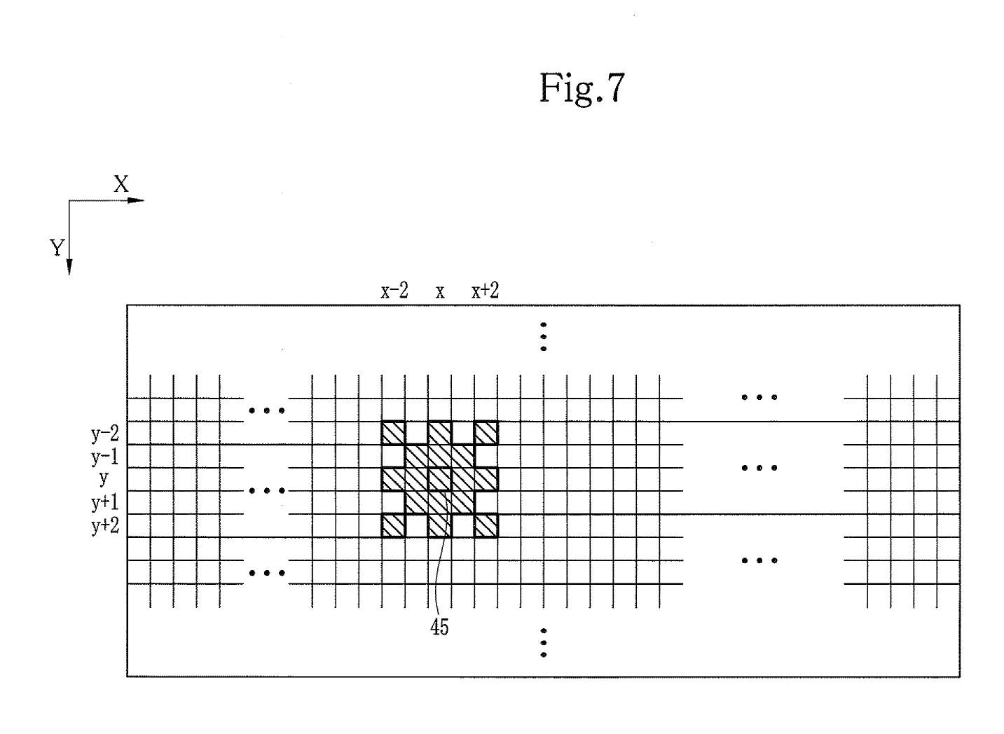

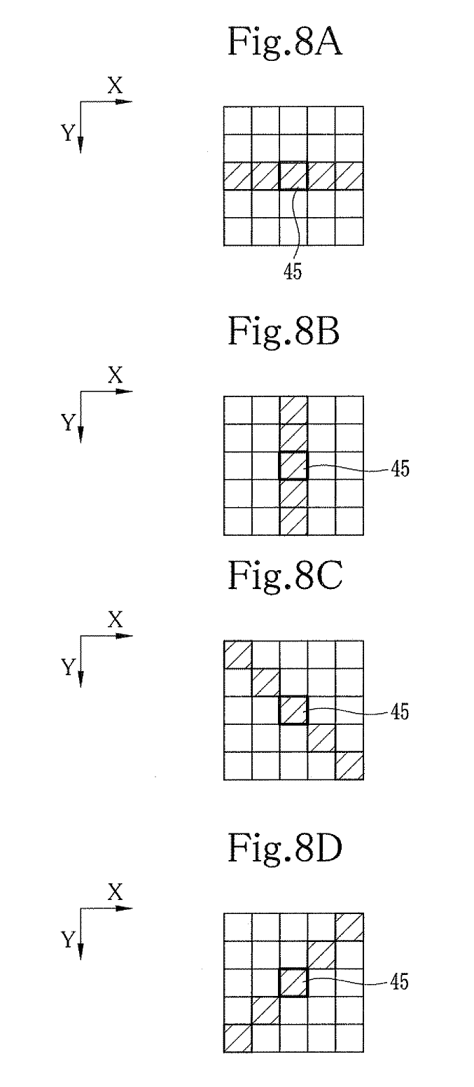

First, the first smoothing unit 43 refers to pixel values of total 17 pixels including the target pixel which are arranged in the X-direction, Y-direction, right diagonal direction, and left diagonal direction, among total 25 pixels of 5×5 pixels centering the target pixel (reference numeral 45 in FIG. 7). Then, the first smoothing unit 43 calculates pixel value distributions of the pixels arranged in all the four directions among the pixels to be referred to, five pixels arranged in the X-direction (pixels with hatching in FIG. 8A), five pixels arranged in the Y-direction (pixels with hatching in FIG. 88), five pixels arranged in the right diagonal direction (pixels with hatching in FIG. 8C), and five pixels arranged in the left diagonal direction (pixels with hatching in FIG. 8D), for the respective directions.

After having obtained the pixel value distributions of the pixels arranged in these four directions, the first smoothing unit 43 specifies a direction corresponding to the smallest pixel value distribution among the obtained pixel value distributions of the pixels in the total four directions. Lastly, the first smoothing unit 43 defines the pixel values of the pixels arranged in the distribution direction providing the smallest pixel value distribution as P(1) to P(5), respectively, and carries out smoothing processing using following formula (4). Here, in formula (4), Q(x, y) shows the pixel value of the target pixel before the first smoothing unit 43 performs the anisotropic smoothing processing, in other words, the pixel value of the target pixel which has been subjected to the projecting noise removal processing, and S(x, y) shows the pixel value of the target pixel which has been subjected to the anisotropic smoothing processing by the first smoothing unit 43.

$$\begin{matrix}[ Formula 4 ] & \\ S ( x , y ) = Q ( x , y ) - \frac{1}{5} {\sum }_{n = 1}^{5} EPS ( Q ( x , y ) - P ( n ) , th 2 ) & ( 4 )\end{matrix}$$

Note that, the function EPS(d, th) is the function shown in above formula (3). Here, the coefficient th2 is set to be a value approximately three times of the standard deviation for noise generated in the input image.

The second smoothing unit 44 carries out isotropic smoothing processing for the pixel value of the target pixel which has been subjected to the anisotropic smoothing processing by the first smoothing unit 43, with reference to the pixels stored in the line memory 41. This second smoothing unit 44 carries out smoothing processing using an isotropic ε-filter. Note that this second smoothing unit 44 has the same function as the smoothing unit of the first embodiment. This second smoothing unit 44 carries out the smoothing processing using following formula (5), by setting the pixel values of total 25 pixels of 5×5 pixels centering the target pixel as reference pixel values among the pixel values of the pixels stored in the line memory 41.

$$\begin{matrix}[ Formula 5 ] & \\ T ( x , y ) = S ( x , y ) - \frac{1}{25} {\sum }_{i = - 2}^{2} {\sum }_{j = - 2}^{2} EPS ( S ( x , y ) - P ( x + i , y + j ) , th 3 ) & ( 5 )\end{matrix}$$

Here, in formula (5), T(x, y) shows the pixel value of the target pixel which has been subjected to the isotropic smoothing processing by the second smoothing unit 44. Further, in formula (5), the coefficient th3 is set to be a value one and a half times of the standard deviation for noise generated in the image, for example. Note that, since the first smoothing unit 43 has performed the anisotropic smoothing processing, the value of the coefficient th3 is set to be a value smaller than the coefficient th2.

In the following, noise removal processing flow in the noise removal unit 16 will be explained. The image data which has been subjected to the color interpolation processing by the color interpolation unit 15 is input into the noise removal unit 16 after the RGB-to-YCbCr conversion has been provided. Note that the noise removal unit 16 inputs the pixel value of each pixel on a pixel-to-pixel basis. This pixel value of each pixel input into the noise removal unit 16 is stored sequentially into the line memory 41. Then, when the number of pixel values of the pixels stored in the line memory 41 reaches a preliminarily set number, input the pixel value of the pixel into the noise removal unit 16 is stopped.

When input of the pixel value of the pixel into the noise removal unit 16 has been stopped, the projection removal unit 42 reads out pixel values of total nine pixels of 3×3 pixels centering the pixel having the coordinates (x, y) of the target pixel and carries out the above projecting noise removal processing. Note that the pixel value of the target pixel which has been subjected to the projecting noise removal processing is output from the projection removal unit 42 to the first smoothing unit 43. The first smoothing unit 43 sets the pixel at the coordinates (x, y) as the target pixel and reads out the pixel values of total 17 pixels including the target pixel, five pixels arranged in the X-direction (pixels in FIG. 8A), five pixels arranged in the Y-direction (pixels in FIG. 8B), five pixels in the right diagonal direction (pixels in FIG. 8C), and five pixels in the left diagonal direction (pixels in FIG. 8D). Then, the first smoothing unit 43 calculates pixel value distributions of the pixels in the four directions, the X-direction, Y-direction, right diagonal direction, and left diagonal direction, using the read out pixel values of the pixels. After having calculated these pixel value distributions, the first smoothing unit 43 carries out the anisotropic smoothing processing using the pixel values of the pixels arranged in a direction providing the smallest pixel value distribution and the pixel value of the target pixel which has been subjected to the projecting noise removal processing and output from the projection removal unit 42. The pixel value of the target pixel which has been subjected to this anisotropic smoothing processing is output to the second smoothing unit 44.

The second smoothing unit 44 reads out the pixel values of total 25 pixels of 5×5 pixels centering the target pixel from the line memory 41. Then, the second smoothing unit carries out the isotropic smoothing processing with reference to the pixel value of the target pixel which has been subjected to the anisotropic smoothing processing and output from the first smoothing unit 43 and the pixel values of the pixels read out from the line memory 41. The pixel value of the target pixel which has been subjected to the isotropic smoothing processing in this second smoothing unit 44 is output from the noise removal unit 16 to the contour enhancement unit 17.

When the pixel value of the target pixel which has been subjected to the isotropic smoothing processing by the second smoothing unit 44 is output from the noise removal unit, the noise removal unit 16 inputs the pixel value of a new pixel. In time with this input, the pixel value of the temporally oldest pixel (e.g., pixel of the coordinates (x−2, y−2)) among the pixel values of the pixels stored in the line memory 41 is deleted from the line memory 41 and the pixel value of the newly input pixel (e.g., pixel of the coordinates (x+3, y+2)) is stored into the line memory 41.

Also in this case, the pixel of the coordinates (x+1, y) which is shifted in the X direction by one pixel from the pixel of the coordinates (x, y) is set as the target pixel as in the first embodiment, and the above projecting noise removal processing and the above plural steps of smoothing processing are carried out. In this manner, every time when all the pixels included in the predetermined range is stored into the line memory 41 or when the pixel value of the pixel stored in the line memory 41 is updated, the above projecting noise removal processing and smoothing processing are carried out. These processing steps are carried out for all the pixels included in the image. Note that, when a pixel positioned at the right or left end part or the upper or lower end part of the image is set as the target pixel, some reference pixels around the target pixel do not exist sometimes. In such a case, pixels around the target pixel may be duplicated to be used or only pixels existing around the target pixel may be used.

This second embodiment performs each processing step of the projecting noise removal processing, the anisotropic smoothing processing, and the isotropic smoothing processing using the pixel values of the pixels stored in the line memory 41. Further, the line memory 41 stores not the whole image but the pixel values of the pixels in the predetermined range including the pixels necessary for the projecting noise removal processing and the plural steps of the smoothing processing. That is, by carrying out the present invention, it is possible to minimize the number of line memories 41 and the capacity of the line memory 41 with respect to the noise removal processing and resultantly it is possible to suppress cost.

In this second embodiment, when pixel value distributions in the four directions are calculated in the first smoothing processing using the ε-filter depending on anisotropy, the pixel value distribution of the pixels arranged in a contour line direction shows the smallest value. That is, this first smoothing processing performs the smoothing processing with reference to the pixels arranged in the contour line direction, and thereby it is possible to reduce noise generated in the target pixel without losing contour line sharpness of the image. Note that, in the smoothing processing depending on anisotropy in the first smoothing unit 43, the number of pixels to be referred to is small and noise reduction effect is small if only this smoothing processing is used. Accordingly, the isotropic smoothing processing is further performed by the second smoothing unit 44 after the smoothing processing in the first smoothing unit 43, and thereby it becomes possible sufficiently to reduce noise generated in the image. At this time, when the isotropic smoothing processing is carried out by the second smoothing unit 44, the coefficient th3 which is a threshold value is set to be smaller than the coefficient th1 used in the isotropic smoothing processing in the first embodiment, and thereby it is possible to remove noise without losing sharpness of the image.

In the first embodiment and the second embodiment, each of the MAX·MIN filter used for the projection removal processing and the ε-filter used for the smoothing processing is an example and other filters suitable for performing these processing steps can be also used.

Further, while the pixel range to be referred to in the projecting noise removal processing is a range of total 9 pixels of 3×3 pixels and the pixel range to be referred to in the smoothing processing is a range of total 25 pixels of 5×5 pixels, the pixel ranges to be referred to for performing these processing steps are not limited to these ranges and can be set optionally.

While the above second embodiment performs the anisotropic smoothing processing and the isotropic smoothing processing after the projecting noise removal processing, the noise removal processing is not limited to these processing steps and the projecting noise removal processing may be omitted and the anisotropic smoothing and the isotropic smoothing may be performed when the noise removal processing is performed for image data having small projecting noise, for example.

While the above first embodiment sets one pixel as the target pixel and performs the noise removal processing including the projecting noise processing and the smoothing processing for the pixel, the first embodiment is not limited to this case and two or more pixels may be set as the target pixels and then the above noise removal processing can be carried out for these target pixels in parallel. In this case, the plural target pixels to be set include pixels positioned on the same line as one another or pixels neighboring one another. While the number of pixels to be stored in the line memory is increased in this case, the plural line memories need not be provided in parallel and it is possible to save the line memory.

Note that similarly the second embodiment may set the noise removal processing including the projected noise removal processing, the anisotropic smoothing processing, and the isotropic smoothing processing for two or more pixels which are set as the target pixels and can perform the above noise removal processing for each of the target pixels.

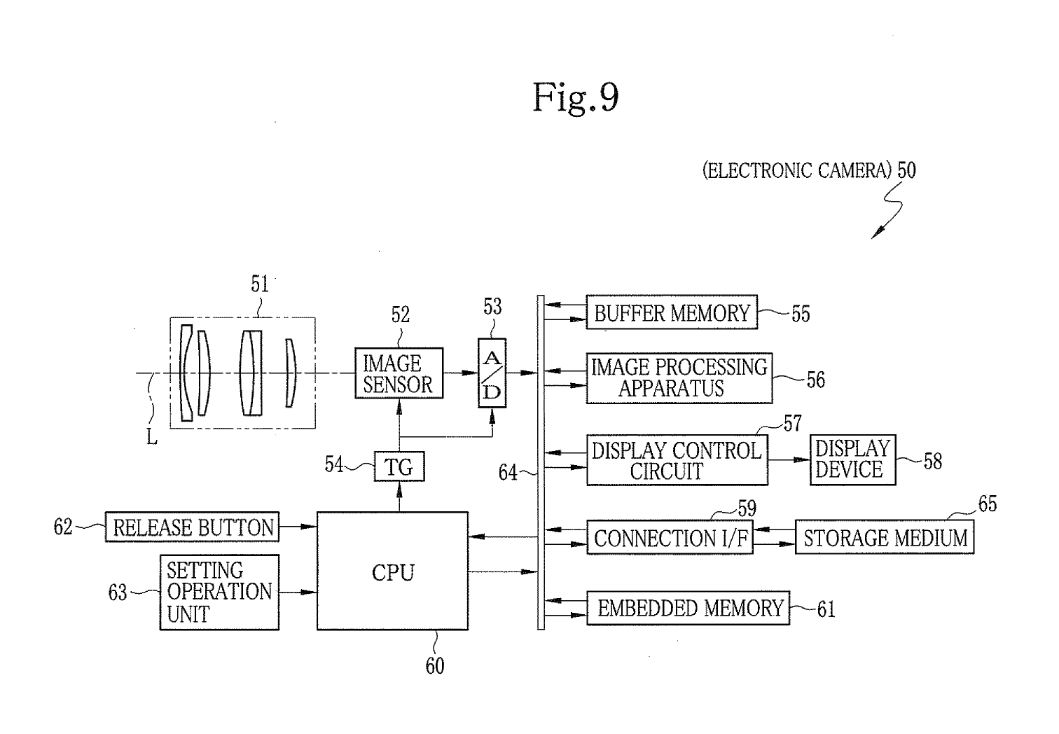

While the first embodiment and the second embodiment are described as the image processing apparatuses, for example, these embodiments are not limited to these examples and the image processing apparatus of the present invention can be mounted on an image processing apparatus used for an electronic camera 50 shown in FIG. 9.

As shown in FIG. 9, the electronic camera 50 includes an imaging optical system 51, an image sensor 52, an A/D converter unit 53, a timing generator (TG) 54, a buffer memory 55, an image processing apparatus 56, a display control circuit 57, a display device 58, a connection I/F 59, a CPU 60, an embedded memory 61, a release button 62, and a setting operation unit 63. Here, the A/D converter unit 53, the buffer memory 55, the image processing apparatus 56, the display control circuit 57, the connection I/F 59, the CPU 60, and the embedded memory 61 are connected to one another by a bus 64. Further, the connection I/F 59 is connected with a storage medium 65 such as a memory card, an optical disk, and a hard disk drive. Note that, the image processing apparatus 56 used in this electronic camera 50 employs an image processing apparatus including the noise removal unit 16 which has either the configuration of the first embodiment or the configuration of the second embodiment.

In the case of this electronic camera 50, when imaging is carried out by the operation of the release button 62, imaging processing is carried out according to a preliminarily set imaging condition. In this imaging processing, photoelectric conversion is carried out in each pixel of the image sensor 52 according to a preliminarily set shutter speed and a signal charge stored in each pixel is output from the image sensor 52 as a pixel signal. The pixel signal output from the image sensor 52 is converted from an analog signal into a digital signal by the A/D converter unit 53. All the pixel signals converted into the digital signals are stored in the buffer memory 55 as one set of data (image data). Here, the image processing apparatus 56 reads out the image data stored in the buffer memory 55 and carries out each of the above processing steps. Also in this case, the same effect as that of the first embodiment and the second embodiment can be obtained.

While the above first embodiment and second embodiment describe the image processing apparatuses, the present invention may be an image processing program for causing a computer to execute either the function of each unit shown in FIG. 1 and FIG. 2 or the function of each unit shown in FIG. 1 and FIG. 6. In this case, the image processing program is preferably stored in a computer-readable storage medium such as a memory card, an optical disk, or a magnetic disk.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An image processing apparatus comprising:
an image importing unit importing an image;
a storage unit storing pixel values of a plurality of pixels included in a predetermined range of the image;
a first noise removal processing unit carrying out first noise removal processing for a pixel value of a target pixel which is a target of noise removal, with reference to the pixel values of the pixels stored in the storage unit; and
a second noise removal processing unit carrying out second noise removal processing for a pixel value of the target pixel which is subjected to the first noise removal processing, successively immediately after the first noise removal processing by the first noise removal processing unit, with reference to the pixel values of the pixels stored in the storage unit.

2. The image processing apparatus according to claim 1, further comprising
a third noise removal processing unit carrying out third noise removal processing for a pixel value of the target pixel which is subjected to the second noise removal processing, with reference to the pixel values of the pixels stored in the storage unit.

3. The image processing apparatus according to claim 1, wherein
the first noise removal processing is processing which removes projecting noise included in the image.

4. The image processing apparatus according to claim 1, wherein
the first noise removal processing is processing which performs anisotropic smoothing depending on a direction, and
the second noise removal processing is processing which performs isotropic smoothing not depending on the direction.

5. The image processing apparatus according to claim 2, wherein
the first noise removal processing is processing which removes projecting noise included in the image,
the second noise removal processing is processing which performs anisotropic smoothing depending on a direction, and
the third noise removal processing is processing which performs isotropic smoothing not depending on the direction.

6. An electronic camera, comprising:
an image sensor performing photoelectric conversion; and
an image processing apparatus according to claim 1, wherein
the image processing apparatus carries out noise removal processing for an image imported by the image sensor.

7. A non-transitory computer readable medium storing an image processing program causing a computer to execute:
an image importing step of importing an image;
a storage step of storing pixel values of a plurality of pixels included in a predetermined range of the image;
a first noise removal step of carrying out first noise removal processing for a pixel value of a target pixel which is a target of noise removal, with reference to the pixel values of the pixels stored by the storage step; and
a second noise removal step of carrying out second noise removal processing for a pixel value of the target pixel which is subjected to the first noise removal processing, successively immediately after the first noise removal processing by the first noise removal step, with reference to the pixel values of the pixels stored by the storage step.
